(19) United States
(12) Patent Application Publication
(10) Pub. No.: US 2026/0270746 A1
(43) Pub. Date: Sep. 10, 2026

(54) CONDITIONS FOR UNSOLICITED UNAVAILABILITY REPORTING

(71) Applicant: QUALCOMM Incorporated, San Diego, CA (US)

(72) Inventors: Sherief HELWA, San Diego, CA (US); Alfred ASTERJADHI, San Diego, CA (US); George CHERIAN, San Diego, CA (US); Abhishek Pramod PATIL, San Diego, CA (US); Gaurang NAIK, San Diego, CA (US); Sanket Sanjay KALAMKAR, San Diego, CA (US); Giovanni CHISCI, San Diego, CA (US); Sai Yiu Duncan HO, San Diego, CA (US)

(21) Appl. No.: 19/070,853

(22) Filed: Mar. 5, 2025

(51) Int. Cl. H04W 24/10

(52) U.S. Cl. CPC H04W 24/10

(57) ABSTRACT

This disclosure provides methods, components, devices and systems for conditions for unsolicited unavailability reporting. Some aspects more specifically relate to threshold durations for transmitting unsolicited unavailability reports and monitoring quantities of unsolicited unavailability reports transmitted by a STA. In some examples, the STA may be disallowed from transmitting an unavailability report until a threshold duration has elapsed since transmission of a pervious unavailability report. In some examples, the AP may monitor the quantity of unavailability reports that the STA transmits and administer a penalty to the STA if the quantity exceeds a threshold. In some examples, the AP may credit the STA with a quantity of unsolicited unavailability reports. In some other examples, the AP may issue warnings to the STA when the quantity has exceeded the threshold and may penalize the STA if the STA fails to comply with the issued warnings.

### TECHNICAL FIELD

This disclosure relates generally to wireless communication and, more specifically, to conditions for unsolicited unavailability reporting.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some cases, a STA may operate according a mode of operation in which the STA transmits unavailability information (such as a duration and start time of unavailability of the STA) to an associated AP). In such cases, the STA may transmit solicited unavailability reports at the request of the AP or transmit unsolicited unavailability reports, which may not be at the request of the AP. In unsolicited unavailability reports, the STA may contend for the wireless medium frequently to transmit the unsolicited unavailability reports, which may reduce or otherwise degrade communications.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a wireless station (STA). The method may include receiving one or more messages that indicate a threshold duration associated with communication of consecutive unavailability reports from the wireless STA, transmitting, while operating in a first mode of operation, a first initial control frame (ICF) including a first unavailability report, the first unavailability report being transmitted at least the threshold duration after transmission of a second unavailability report from the wireless STA in accordance with receiving the one or more messages, and receiving an initial control response (ICR) frame in response to transmitting the first ICF.

Another innovative aspect of the subject matter described in this disclosure can be implemented in a wireless STA for wireless communication. The wireless STA may include a processing system that includes processor circuitry and memory circuitry that stores code. The processing system may be configured to cause the wireless STA to receive one or more messages that indicate a threshold duration associated with communication of consecutive unavailability reports from the wireless STA, transmit, while operating in a first mode of operation, a first ICF including a first unavailability report, the first unavailability report being transmitted at least the threshold duration after transmission of a second unavailability report from the wireless STA in accordance with receiving the one or more messages, and receive an ICR frame in response to transmitting the first ICF.

Another innovative aspect of the subject matter described in this disclosure can be implemented in a wireless STA for wireless communication. The wireless STA may include means for receiving one or more messages that indicate a threshold duration associated with communication of consecutive unavailability reports from the wireless STA, means for transmitting, while operating in a first mode of operation, a first ICF including a first unavailability report, the first unavailability report being transmitted at least the threshold duration after transmission of a second unavailability report from the wireless STA in accordance with receiving the one or more messages, and means for receiving an ICR frame in response to transmitting the first ICF.

Another innovative aspect of the subject matter described in this disclosure can be implemented in a non-transitory computer-readable medium storing code for wireless communication. The code may include instructions executable by one or more processors to receive one or more messages that indicate a threshold duration associated with communication of consecutive unavailability reports from the wireless STA, transmit, while operating in a first mode of operation, a first ICF including a first unavailability report, the first unavailability report being transmitted at least the threshold duration after transmission of a second unavailability report from the wireless STA in accordance with receiving the one or more messages, and receive an ICR frame in response to transmitting the first ICF.

Some examples of the method, wireless STAs, and non-transitory computer-readable medium described herein may further include operations, features, means, or instructions for receiving one or more second messages that indicate one or more updates to the first mode of operation at the wireless STA, the one or more second messages further indicating a second threshold duration and transmitting a second ICF including a third unavailability report after at least the second threshold duration from transmission of a previous unavailability report.

Another innovative aspect of the subject matter described in this disclosure can be implemented in a method for wireless communication at a wireless access point (AP). The method may include transmitting one or more messages that indicate a threshold duration associated with communication of consecutive unavailability reports from a wireless STA, receiving, from the wireless STA, a first unavailability report, and receiving from the wireless STA, an ICF including a second unavailability report, the second unavailability report being received at the AP at least after the threshold duration from reception of the first unavailability report.

Another innovative aspect of the subject matter described in this disclosure can be implemented in a wireless AP. The wireless AP may include a processing system that includes processor circuitry and memory circuitry that stores code. The processing system may be configured to cause the wireless AP to transmit one or more messages that indicate a threshold duration associated with communication of consecutive unavailability reports from a wireless STA, receive, from the wireless STA, a first unavailability report, and receive from the wireless STA, an ICF including a second unavailability report, the second unavailability report being received at the AP at least after the threshold duration from reception of the first unavailability report.

Another innovative aspect of the subject matter described in this disclosure can be implemented in a wireless AP. The wireless AP may include means for transmitting one or more messages that indicate a threshold duration associated with communication of consecutive unavailability reports from a wireless STA, means for receiving, from the wireless STA, a first unavailability report, and means for receiving from the wireless STA, an ICF including a second unavailability report, the second unavailability report being received at the AP at least after the threshold duration from reception of the first unavailability report.

Another innovative aspect of the subject matter described in this disclosure can be implemented in a non-transitory computer-readable medium storing code for wireless communication. The code may include instructions executable by one or more processors to transmit one or more messages that indicate a threshold duration associated with communication of consecutive unavailability reports from a wireless STA, receive, from the wireless STA, a first unavailability report, and receive from the wireless STA, an ICF including a second unavailability report, the second unavailability report being received at the AP at least after the threshold duration from reception of the first unavailability report.

In some examples of the method, wireless APs, and non-transitory computer-readable medium described herein, the one or more messages include one or more first dynamic unavailability operation (DUO) enablement messages and the method, apparatuses, and non-transitory computer-readable medium may include further operations, features, means, or instructions for transmitting one or more second DUO enablement messages that indicate a second threshold duration associated with unavailability reporting a second wireless STA, the second threshold duration being different from the threshold duration.

Another innovative aspect of the subject matter described in this disclosure can be implemented in a method for wireless communication at a wireless access point (AP). The method may include receiving, from a wireless STA operating in a first mode of operation, an ICF including an unavailability report, a quantity of unsolicited unavailability reports received from the wireless STA being incremented in accordance with receiving the ICF, transmitting an ICR frame in response to the ICF, and restricting communication of one or more subsequent unavailability reports between the wireless AP and the wireless STA in accordance with the quantity of unsolicited unavailability reports.

Another innovative aspect of the subject matter described in this disclosure can be implemented in a wireless AP. The wireless AP may include a processing system that includes processor circuitry and memory circuitry that stores code. The processing system may be configured to cause the wireless AP to receive, from a wireless STA operating in a first mode of operation, an ICF including an unavailability report, a quantity of unsolicited unavailability reports received from the wireless STA being incremented in accordance with receiving the ICF, transmit an ICR frame in response to the ICF, and restrict communication of one or more subsequent unavailability reports between the wireless AP and the wireless STA in accordance with the quantity of unsolicited unavailability reports.

Another innovative aspect of the subject matter described in this disclosure can be implemented in a wireless AP. The wireless AP may include means for receiving, from a wireless STA operating in a first mode of operation, an ICF including an unavailability report, a quantity of unsolicited unavailability reports received from the wireless STA being incremented in accordance with receiving the ICF, means for transmitting an ICR frame in response to the ICF, and means for restricting communication of one or more subsequent unavailability reports between the wireless AP and the wireless STA in accordance with the quantity of unsolicited unavailability reports.

Another innovative aspect of the subject matter described in this disclosure can be implemented in a non-transitory computer-readable medium storing code for wireless communication. The code may include instructions executable by one or more processors to receive, from a wireless STA operating in a first mode of operation, an ICF including an unavailability report, a quantity of unsolicited unavailability reports received from the wireless STA being incremented in accordance with receiving the ICF, transmit an ICR frame in response to the ICF, and restrict communication of one or more subsequent unavailability reports between the wireless AP and the wireless STA in accordance with the quantity of unsolicited unavailability reports.

Some examples of the method, wireless APs, and non-transitory computer-readable medium described herein may further include operations, features, means, or instructions for transmitting one or more messages that indicate a credit of unsolicited unavailability reports the wireless STA may be permitted to transmit, the credit of unsolicited unavailability reports being decremented in accordance with receiving the ICF, and restricting the communication of the one or more subsequent unavailability reports between the wireless AP and the wireless STA being in accordance with the credit of unsolicited unavailability reports being decremented to zero.

Some examples of the method, wireless APs, and non-transitory computer-readable medium described herein may further include operations, features, means, or instructions for transmitting, in response to receiving the ICF, one or more warning messages that indicate for the wireless STA to reduce a frequency at which the wireless STA communicates unsolicited unavailability reports, the one or more warning messages being transmitted in accordance with the quantity of unsolicited availability reports received from the wireless STA satisfying a threshold quantity of unsolicited unavailability reports.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIGS. 2A and 2B show examples of signaling diagrams that illustrate solicited and unsolicited unavailability reporting at a station (STA) and support conditions for unsolicited unavailability reporting.

FIG. 3 shows an example of a process flow that illustrates various signaling steps between a STA and an access point (AP) that support conditions for unsolicited unavailability reporting.

FIG. 4 shows a block diagram of an example wireless communication device that supports conditions for unsolicited unavailability reporting.

FIG. 5 shows a block diagram of an example wireless communication device that supports conditions for unsolicited unavailability reporting.

FIG. 6 shows a flowchart illustrating an example process performable by or at a wireless STA that supports conditions for unsolicited unavailability reporting.

FIGS. 7 and 8 show flowcharts illustrating example processes performable by or at a wireless AP that supports conditions for unsolicited unavailability reporting.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a wireless station (STA) (otherwise referred to as a STA) may be enabled in a dynamic unavailability operation (DUO) mode, such as a first mode of operation, a mode of operation in which the STA reports unavailability information to a peer STA, among other examples. While operating in the DUO mode, the STA may indicate time periods during which the STA is unavailable for communication with a wireless access point (AP). In some examples, the STA operating in the DUO mode may be permitted to transmit solicited unavailability reports, which may be requested by the AP, or may be permitted to transmit unsolicited unavailability reports. For example, in accordance with unsolicited unavailability reporting, the STA may transmit, to the AP via an initial control frame (ICF), an unavailability report indicating that the STA is unavailable for a specified duration starting at a specified time. The AP may respond to the unavailability report with an initial control response (ICR) frame which acknowledges receipt of the unavailability report. However, a STA which is permitted to transmit unsolicited reports may abuse the feature of unsolicited reporting and may transmit numerous unsolicited reports, which may result in cluttering of the communication medium.

Various aspects relate generally to conditions for unsolicited unavailability reporting at a STA. Some aspects more specifically relate to threshold durations for transmitting unsolicited unavailability reports and monitoring quantities of unsolicited unavailability reports transmitted by a STA. In some examples, the STA may be disallowed from transmitting an unavailability report until a threshold duration has elapsed since transmission of a pervious unavailability report. In some other examples, the AP may monitor the quantity of unavailability reports that the STA transmits and administer a penalty to the STA if the quantity exceeds a threshold. For example, the AP may credit the STA with a quantity of unsolicited unavailability reports and may subtract from the credit each time the STA transmits an unsolicited unavailability report. In response to the credit being decremented to zero, the STA may be disallowed from transmitting any additional unsolicited unavailability reports. In some other examples, the AP may issue warnings to the STA, and, in response to a quantity of warning message satisfying a threshold, may penalize the STA (such as via disassociation or DUO mode disablement/suspension).

Particular aspects of the subject matter described in this disclosure can be implemented to realize one or more of the following potential advantages. In some examples, by configuring a threshold duration from a first unavailability report before transmission of a subsequent unsolicited unavailability report, the described techniques may be used to reduce traffic of a communication medium between the STA and the AP, which may increase throughput and reduce data loss. In some other examples, by restricting further access to unsolicited unavailability reports for STAs, the described techniques may reduce interference and increase coordination between wireless communication devices.

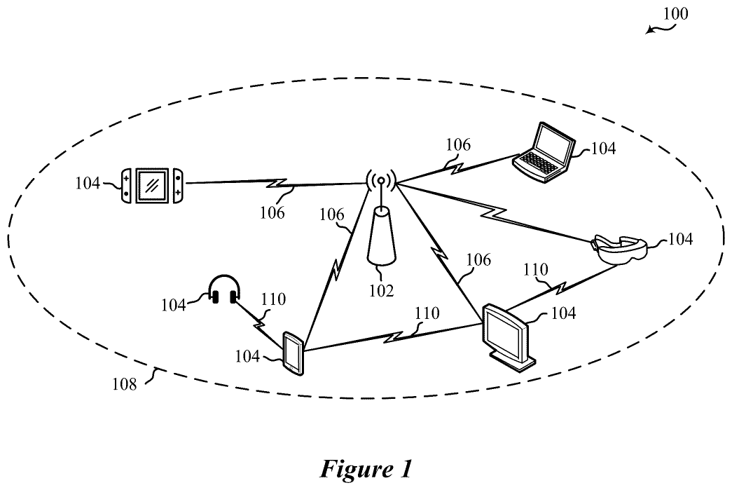

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

In some wireless communication networks, a STA 104 may be enabled in a DUO mode. The DUO mode of the STA 104 may be associated with a configuration of the STA 104 to indicate time periods during which the STA 104 is unavailable for communication with an AP 102. In some examples, the STA 104 operating in the DUO mode may be permitted to transmit solicited unavailability reports, which may be requested by the AP 102, or may be permitted to transmit unsolicited unavailability reports. For example, in accordance with unsolicited unavailability reporting, the STA 104 may transmit, to the AP 102 via an ICF, an unavailability report indicating that the STA is unavailable for a specified duration after the unavailability report. The AP 102 may respond to the unavailability report with an ICR frame which acknowledges receipt of the unavailability report. However, an STA 104 which is permitted to transmit unsolicited reports may abuse the feature of unsolicited reporting and may transmit numerous unsolicited reports, which may result in cluttering of the communication medium.

In some examples, the STA 104 may be disallowed from transmitting an unavailability report until a threshold duration has elapsed since transmission of a pervious unavailability report. In some other examples, the AP 102 may monitor the quantity of unavailability reports that the STA 104 transmits and administer a penalty to the STA 104 if the quantity exceeds a threshold. In some examples, the AP 102 may credit the STA 104 with a quantity of unsolicited unavailability reports and may subtract from the credit each time the STA 104 transmits an unsolicited unavailability report. When the credit runs out, the STA 104 is disallowed from transmitting any additional unavailability reports. In some other examples, the AP 102 may issue warnings to the STA 104 when the quantity has exceeded the threshold and may penalize the STA 104 (such as via disassociation or DUO mode disablement/suspension) if the STA 104 fails to comply with the issued warnings.

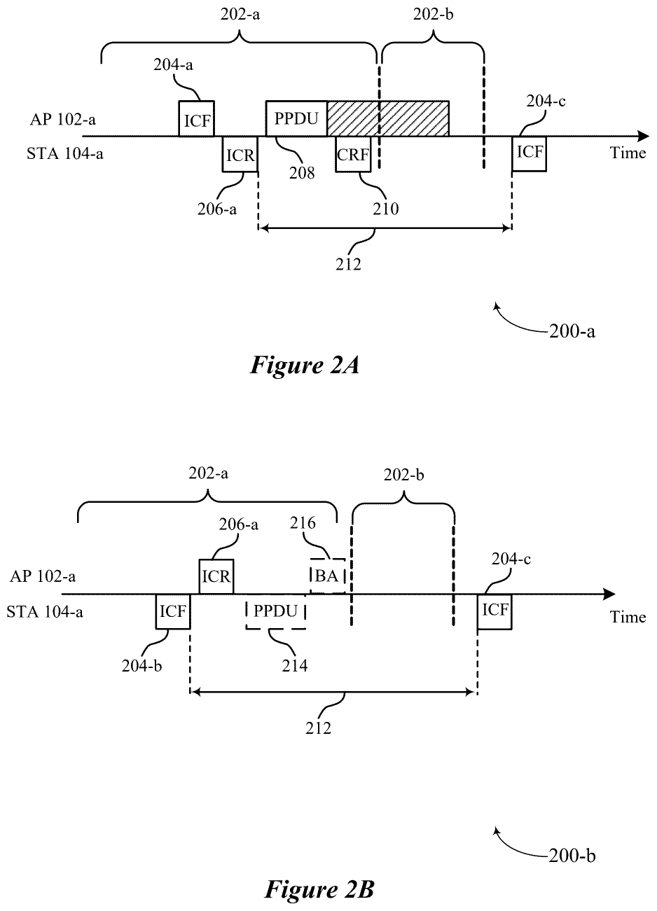

FIGS. 2A and 2B show examples of a signaling diagram 200-a and a signaling diagram 200-b that support conditions for unsolicited unavailability reporting. In some examples, the signaling diagram 200-a and the signaling diagram 200-b may implement aspects of the wireless communication network 100. For example, the signaling diagram 200-a and the signaling diagram 200-b includes an AP 102-a and a STA 104-a, which may be examples of the corresponding devices described with reference to FIG. 1. The AP 102-a may be referred to as a peer STA (such as acting as an AP 102) and the STA 104-a may be in a CoEx mode and may experience in-device coexistence (IDC) interference (such as interference as a result of the CoEx mode that causes one or more periods of unavailability at the STA 104-a). Additionally, or alternatively, the AP 102-a and the STA 104-a may each be examples of other types of wireless devices, such as a UE or another type of transmitter or receiver. Thus, although aspects of the present disclosure are described with reference to an AP 102 and a STA 104, it is understood that the described techniques may be performed by a wireless device different from an AP 102 and a STA 104.

The signaling diagrams 200-a and 200-b illustrate examples in which the STA 104-a is in a CoEx mode. For example, the AP 102-a may transmit, to the STA 104-a, an indication that the STA 104-a is to operate in the CoEx mode. While operating in the CoEx mode, the STA 104-a may be available for data message reception during a first time period 202-a and may be unavailable for data message reception during a second time period 202-b. However, the AP 102-a may be unaware of the unavailability of the STA 104-a during the second time period 202-b and may schedule data message transmissions (such as such as transmission of the PPDU 208) at least partially overlapping the second time period 202-b while the STA 104-a is unavailable to receive the PPDU 208.

The signaling diagram 200-a may illustrate an example of solicited unavailability reporting by the STA 104-a, and the ICR 206-a may include a solicited unavailability report. For example, to avoid transmitting the PPDU 208 while the STA 104-a is unavailable (for example, due to IDC transmissions at the STA 104-a), the AP 102-a may transmit, to the STA 104-a, an ICF 204-a that solicits or requests unavailability information from the STA 104-a. Based on the ICF 204-a, the STA 104-a may transmit, to the AP 102-a, an ICR 206-a that includes the unavailability information (such as indicating that the STA 104-a is available for downlink data transmissions during the first time period 202-a and is unavailable for downlink data transmissions during the second time period 202-b). Based on the ICR 206-a, the AP 102-a may adjust a timing, a duration, or both of the PPDU 208 (such as truncate the PPDU 208) to a level that allows for the PPDU 208 and a response (such as the CRF 210 including unavailability information, a BA 216 bitmap, or both) within the first time period 202-a while the STA 104-a is available. The signaling diagram 200-a may illustrate an example of solicited unavailability reporting, and the ICF 204-a may include a solicited unavailability report.

The signaling diagram 200-b may illustrate an example of unsolicited unavailability reporting by the STA 104-a, and the ICF 204-b may include an unsolicited unavailability report. For example, the STA 104-a may contend for a wireless communication medium to transmit, to the AP 102-a, an ICF 204-b that includes the unavailability information (such as indicating that the STA 104-a is available for downlink data transmissions during the first time period 202-a and is unavailable for downlink data transmissions during the second time period 202-b). The AP 102-a may transmit an ICR 206-a that confirms (such as acknowledges) receipt of the unavailability information in the ICF 204-b. Based on the ICF 204-b, the AP 102-a may take into consideration the time period 202-b during which the STA 104-a is unavailable in scheduling future TXOPs. For example, the AP 102-a may schedule transmission of a PPDU (such as or other transmission) for the STA 104-a such that the PPDU does not overlap with the time period 202-b.

Unavailability reporting by the STA 104-a (such as via a solicited report in the ICR 206-a or an unsolicited report in the ICF 204-b) may be in accordance with enablement of a DUO mode, such as a first mode of operation, at the STA 104-a. For example, the AP 102-a may transmit one or more messages to enable the DUO mode at the STA 104-a, which may enable the STA 104-a to perform solicited unavailability reporting, unsolicited unavailability reporting, or both.

In some examples, unsolicited unavailability reporting (such as via the ICF 204-b) may be allowed without constraint (such as without limit on quantity or frequency). In such examples, the STA 104-a may repeatedly attempt to access the communication medium to report unavailability information to the AP 102-a. However, the STA 104-a may clutter the communication medium by transmitting an excessive quantity of unsolicited unavailability reports. For example, the STA 104-a may inaccurately predict its unavailability information in future time periods which may lead to a relatively large quantity of reports sent by the STA 104-a to update the unavailability information each time the STA 104-a becomes aware of a change in the timing information of its future unavailability. Additionally, or alternatively, a relatively increased quantity of STAs 104 may support unavailability reporting, which may lead to more STAs 104 attempting to access the communication to medium to report their respective unavailability information during such unsolicited reporting.

In accordance with examples described herein, the STA 104-a may adhere to one or more conditions which indicate whether unsolicited unavailability reporting is allowed for the STA 104-a and indicate a quantity of unsolicited unavailability reports (such as within a time period) that are permitted for transmission by the STA 104-a. In some examples, the conditions may be enforceable by the AP 102-a. For example, if the STA 104-a abuses unavailability reporting (such as by exceeding a threshold quantity of reports, by ignoring warning messages), the AP 102-a may apply a penalty to the STA 104-a.

In some implementations, the STA 104-a operating in the DUO mode may be allowed to transmit an unsolicited unavailability report if it is accompanied by uplink data (such as quality of service data, a PPDU 214) in an uplink TXOP. In some examples, sending one or more uplink quality of service null frames (such as QoS Null frames) to indicate the unavailability information in the uplink TXOP may not be allowed (such as may exempt the unavailability information from being permitted in the uplink TXOP). For example, the STA 104-a may transmit the unavailability information in an uplink TXOP that is allocated for the PPDU 214 due to the PPDU 214 also being transmitted in the uplink TXOP (such as, if the STA 104-a has an uplink QoS data pending transmission).

In some implementations, the STA 104-a operating in the DUO mode may be allowed to transmit unavailability reports a threshold quantity (such as maximum quantity N) of times within each beacon interval. The threshold quantity of unavailability reports permitted within each beacon interval may be indicated by the AP 102-a via a beacon frame, a probe response frame, or any other examples of management frames. In some examples, the AP 102-a may indicate the threshold quantity of unsolicited unavailability reports during the DUO establishment procedure and may update the threshold quantity of unsolicited unavailability reports during a DUO modification procedure.

In some implementations, the STA 104-a operating in the DUO mode may be disallowed from transmitting unavailability reports unless a threshold duration 212 (such as T ms) has elapsed since a previous unavailability report. For example, the STA 104-a may transmit unavailability reports such that a duration between communication of consecutive unavailability reports is at least the threshold duration 212. In some examples, the STA 104-a may receive an indication (such as announcement) of the threshold duration 212 from the AP 102-a. For example, the AP 102-a may transmit the indication of the threshold duration 212 via a beacon frame, a probe response frame, or any other management frame. Additionally, or alternatively, the AP 102-a may transmit the indication of the threshold duration 212 via one or more first messages associated with a DUO mode enablement at the STA 104-a or one or more second messages associated with a DUO mode update at the STA 104-a. Accordingly, the AP 102-a may configure respective threshold durations for each STA 104 which is in communication with the AP 102-a via such DUO mode enablement and modification procedures.

In some examples, the threshold duration 212 elapsed since communication of a previous unavailability report may be with respect to any previous unavailability report (such as both solicited and unsolicited reports). For example, the STA 104-a may transmit the ICR 206-a which includes a solicited unavailability report, and the STA 104-a may wait until at least the threshold duration 212 has elapsed prior to transmitting an ICF 204-c that includes an unsolicited unavailability report. In some examples, in accordance with (as a reaction to) transmitting the ICR 206-a that includes the solicited unavailability report, the STA 104-a may initiate (such as reset) a timer equal to the threshold duration 212 and may transmit the ICF 204-c after the timer has expired.

In some other examples, the threshold duration 212 elapsed since communication of a previous unavailability report may be with respect to unsolicited unavailability reports (such as solicited unavailability reports may not be counted toward the restriction). For example, the STA 104-a may transmit the ICR 206-a at a first time which includes a solicited unavailability report, and the STA 104-a may transmit the ICF 204-c that includes an unsolicited unavailability report at a second time that is less than the threshold duration 212 from the first time. In some examples, in response to transmitting the ICR 206-a that includes the solicited unavailability report, the STA 104-a may refrain from initiating (such as resetting) the timer equal to the threshold duration 212 and may transmit the ICF 204-c at any time after the ICR 206-a given that the threshold duration condition is satisfied with respect to the last transmitted unsolicited unavailability report.

In either case, the threshold duration 212 elapsed since communication of a previous unavailability report may apply in cases where the previous unavailability report is an unsolicited unavailability report. For example, the STA 104-a may transmit the ICF 204-b which includes a first unsolicited unavailability report, and the STA 104-a may wait until at least the threshold duration 212 has elapsed prior to transmitting an ICF 204-c that includes a second unsolicited unavailability report. In some examples, in response to transmitting the ICF 204-b that includes the first unsolicited unavailability report, the STA 104-a may initiate (such as reset) a timer equal to the threshold duration 212 and may transmit the ICF 204-c only after the timer has expired.

Accordingly, the threshold duration 212 may apply in cases where transmission of a second unsolicited unavailability report follows transmission of a first unsolicited unavailability report (such as the second unsolicited unavailability report is transmitted at least the threshold duration 212 after the previous unavailability report). Additionally, or alternatively, the threshold duration 212 may apply in cases where transmission of an unsolicited unavailability report follows transmission of a solicited unavailability report (such as the unsolicited unavailability report is transmitted at least the threshold duration 212 after the previous solicited unavailability report).

In some examples, unsolicited unavailability reporting may be allowed at any time (such as may be exempt from the threshold duration condition) if the unavailability report is accompanied by the PPDU 214 (such as uplink QoS data, uplink data, among other examples). For example, the STA 104-a may transmit an unsolicited unavailability report via a TXOP that is allocated for the PPDU 214. In such examples, the unsolicited unavailability report transmitted via the TXOP may be transmitted less than a threshold duration 212 from a previous unavailability report.

In some implementations, the AP 102-a may credit the STA 104-a with a quantity of unsolicited unavailability reports the STA 104-a is permitted to transmit. The AP 102-a may indicate the quantity of unsolicited unavailability reports credited to the STA 104-a via one or more messages which enable the DUO mode at the STA 104-a. For each unsolicited unavailability report the STA 104-a transmits, the credit of unsolicited unavailability reports for the STA 104-a may be decremented by one. That is, the STA 104-a, the AP 102-a, or both may manage the credit allocated to the STA 104-a and decrement the credit by one each time the STA 104-a transmits an unsolicited unavailability report. For example, the STA 104-a may transmit the ICF 204-c including the unsolicited unavailability report and may decrement the credit of unsolicited unavailability reports by one in response to transmitting the ICF 204-c. In such cases, the credit of unsolicited unavailability reports may drop to zero, at which point the STA 104-a may be disallowed from (such as may refrain from) transmitting additional unsolicited unavailability reports. In some examples, the AP 102-a may replenish (such as update) the credit of unsolicited unavailability reports for the STA 104-a. For example, the AP 102-a may transmit one or more messages indicating to update a DUO mode at the STA 104-a, and the one more update messages may indicate to update the credit of unsolicited unavailability reports.

In some implementations, the AP 102-a may monitor a quantity and/or frequency of unsolicited unavailability reports the STA 104-a transmits. The AP 102-a may determine that the quantity of unsolicited unavailability reports exceeds a threshold (such as a threshold quantity, a threshold quantity per time period), and the AP 102-a may transmit one or more warning messages that indicate for the STA 104-a to reduce a frequency (such as or quantity) at which the STA 104-a communicates unsolicited unavailability reports. A quantity of warning messages the AP 102-a transmits to the STA 104-a may be fixed or may be configurable (by the AP 102-a). In some examples, the AP 102-a may administer a penalty to the STA 104-a in response to a failure of the STA 104-a to reduce the frequency (such as or quantity) at which the STA 104-a communicates the unsolicited unavailability reports in response to the one or more warning messages. Additionally, or alternatively, the AP 102-a may administer the penalty in response to a quantity of warning messages communicated to the STA 104-a satisfying a threshold quantity of warning messages.

The penalty to the STA 104-a may include restricting communication of subsequent unavailability reports between the STA 104-a and the AP 102-a. For example, the AP 102-a may disassociate the STA 104-a from the AP 102-a. Additionally, or alternatively, the AP 102-a may disable a DUO mode of the STA 104-a or may suspend the DUO mode at the STA 104-a for a duration. To restrict the STA 104-a, the AP 102-a may transmit a control frame, a management frame, or both that indicates that the STA 104-a is suspended from the DUO mode, is suspended for the DUO mode for the duration, or is disabled from using the DUO mode.

In some examples, disabling or suspending the DUO mode at the STA 104-a may be in accordance with an incompatibility between the DUO mode and other modes of operation activated at the STA 104-a. For example, the DUO mode may be incompatible with a coordinated beamforming mode, a coordinated spatial reuse mode, a coordinated time division multiple access mode, or any other mode of operation. The AP 102-a may identify that at least one of the modes of operation incompatible with the DUO mode is activated at the STA 104-a, and the AP 102-a may disable or suspend the DUO mode at the STA 104-a in response to the incompatible mode being activated.

Suspension or disablement of modes of operation at the STA 104-a based on incompatibility is not limited to the DUO mode of operation and may be applicable to other modes of operation at the STA 104-a. For example, the AP 102-a may disable or suspend an enhanced multi-link single-radio (eMLSR) mode, a dynamic power save (DPS) mode, a non-primary channel access (NPCA) mode, a dynamic subband operation (DSO) mode, or any other potential modes of operation at the STA 104-a based on an identification that the mode is incompatible with another activated mode of operation activated or planned to be activated by the AP 102-a, which may include a multi-user operation mode, a coordinated beamforming mode, a coordinated spatial reuse mode, a coordinated time division multiple access mode, a dynamic bandwidth expansion (DBE) mode, or any other mode of operation.

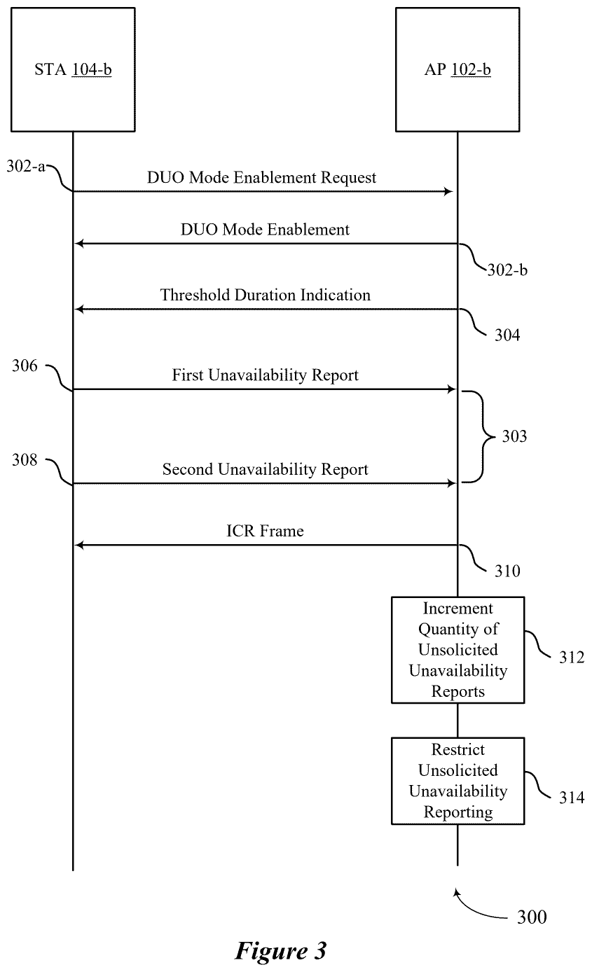

FIG. 3 shows an example of a process flow 300 that supports conditions for unsolicited unavailability reporting. The process flow 300 may implement or may be implemented by aspects of the wireless communication network 100. For example, the process flow 300 may include a STA 104-b and an AP 102-b which may be examples of corresponding devices described herein. In the following description of the process flow 300, the operations may be performed (such as reported or provided) in a different order than the order shown, or the operations performed by the example devices may be performed in different orders or at different times. For example, specific operations also may be left out of the process flow 300, or other operations may be added to the process flow 300. Further, although some operations or signaling may be shown to occur at different times for discussion purposes, these operations may actually occur at the same time.

At 302, the STA 104-b and the AP 102-b may perform a DUO mode enablement procedure. For example, at 302-a, the STA 104-b may transmit a DUO mode enablement request to the AP 102-b, which may include a request, by the STA 104-b, to enter the DUO mode of operation. In response to the DUO mode enablement request, the STA 104-a may receive, from the AP 102-b, an indication to enable a DUO mode of the STA 104- b at 302-b. The DUO mode of the STA 104-b may be in accordance with the STA 104-b being in a CoEx mode and experiencing IDC interference (such as interference as a result of the CoEx mode that causes one or more time periods of unavailability at the STA 104-b).

At 304, the STA 104-b may receive, from the AP 102-b, one or more messages that indicate a threshold duration associated with communication of consecutive unavailability reports from the STA 104-b. For example, the threshold duration may indicate that an unsolicited unavailability report from the STA 104-b is permitted after a threshold duration has elapsed since transmission of an unsolicited unavailability report, or since transmission of either an unsolicited unavailability report or a solicited unavailability report. The one or messages that indicate the threshold duration may include a beacon frame, a probe response frame, a management frame, a DUO mode enablement message, a DUO mode update message, or any combination thereof.

At 306, the STA 104-b may transmit a first unavailability report to the AP 102-b. The first unavailability report may be included in an ICF frame (such as in the case of an unsolicited unavailability report) or may be included in an ICR frame (such as in the case of a solicited unavailability report). At 308, the STA 104-b may transmit a second unavailability report, which may be an unsolicited unavailability report included in an ICF frame. The STA 104-b may transmit the second unavailability report after a duration 303 from the first unavailability report, and the duration 303 may satisfy the threshold duration (such as indicated at 310). At 310, the STA 104-b may receive, from the AP 102-b, an ICR frame which acknowledges receipt of the second unavailability report.

At 312, the AP 102-b may increment a quantity of unsolicited unavailability reports by the STA 104-b in response to receiving the second unavailability report. Incrementing the quantity may be in accordance with a monitoring by the AP 102-b of the quantity of unsolicited unavailability reports received from the STA 104-b. In some examples, the AP 102-b may credit the STA 104-b with a credited quantity of unsolicited unavailability reports, and the credited quantity may be decremented by one in response to receiving the second unavailability report.

At 314, the AP 102-b may restrict communication of one or more subsequent unavailability reports between the AP 102-b and the STA 104-b in accordance with the quantity of unsolicited unavailability reports received from the STA 104-b. For example, the AP 102-b may restrict the communication of the subsequent unavailability reports in response to the quantity of unsolicited unavailability reports exceeding a threshold quantity or frequency or in response to the credited quantity of unsolicited unavailability reports dropping to zero. Restricting the communication of the subsequent unavailability reports may include disassociating the STA 104-b from the AP 102-b, disabling the DUO mode at the STA 104-b, suspending the DUO mode at the STA 104-b for a duration, or any combination thereof.

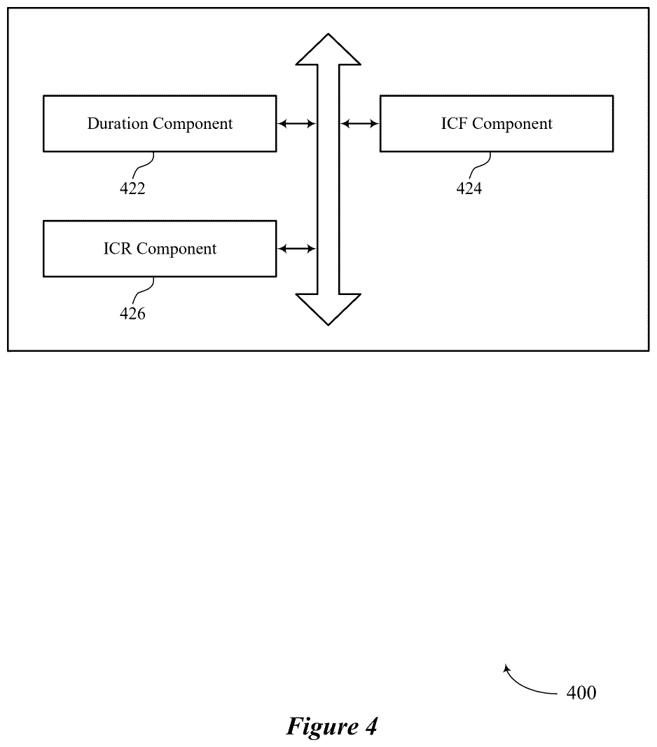

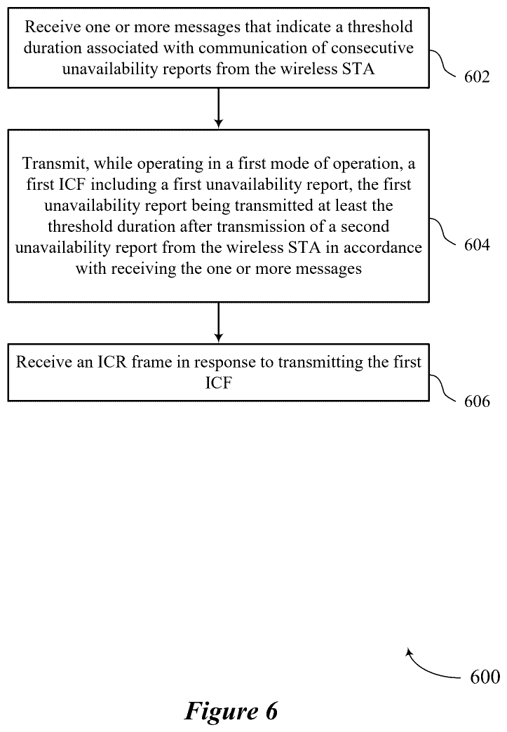

FIG. 4 shows a block diagram of an example wireless communication device 400 that supports conditions for unsolicited unavailability reporting. In some examples, the wireless communication device 400 is configured to perform the process 600 described with reference to FIG. 6. The wireless communication device 400 may include one or more chips, SoCs, chipsets, packages, components or devices that individually or collectively constitute or include a processing system. The processing system may interface with other components of the wireless communication device 400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 400 may transmit the information output from the chip. In such an example, the second interface may refer to an interface between the processing system of the chip and a reception component, such that the wireless communication device 400 may receive information that is then passed to the processing system. In some such examples, the first interface also may obtain information, such as from the transmission component, and the second interface also may output information, such as to the reception component.

The processing system of the wireless communication device 400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein

In some examples, the wireless communication device 400 can be configurable or configured for use in a STA, such as the STA 104 described with reference to FIG. 1. In some other examples, the wireless communication device 400 can be a STA that includes such a processing system and other components including multiple antennas. The wireless communication device 400 is capable of transmitting and receiving wireless communications in the form of, for example, wireless packets. For example, the wireless communication device 400 can be configurable or configured to transmit and receive packets in the form of physical layer PPDUs and MPDUs conforming to one or more of the IEEE 802.11 family of wireless communication protocol standards. In some other examples, the wireless communication device 400 can be configurable or configured to transmit and receive signals and communications conforming to one or more 3GPP specifications including those for 5G NR or 6G. In some examples, the wireless communication device 400 also includes or can be coupled with one or more application processors which may be further coupled with one or more other memories. In some examples, the wireless communication device 400 further includes a user interface (UI) (such as a touchscreen or keypad) and a display, which may be integrated with the UI to form a touchscreen display that is coupled with the processing system. In some examples, the wireless communication device 400 may further include one or more sensors such as, for example, one or more inertial sensors, accelerometers, temperature sensors, pressure sensors, or altitude sensors, that are coupled with the processing system.

The wireless communication device 400 includes a duration component 422, an ICF component 424, and an ICR component 426. Portions of one or more of the duration component 422, the ICF component 424, and the ICR component 426 may be implemented at least in part in hardware or firmware. For example, one or more of the duration component 422, the ICF component 424, and the ICR component 426 may be implemented at least in part by at least a processor or a modem. In some examples, portions of one or more of the duration component 422, the ICF component 424, and the ICR component 426 may be implemented at least in part by a processor and software in the form of processor-executable code stored in memory.

The wireless communication device 400 may support wireless communication in accordance with examples as disclosed herein. The duration component 422 is configurable or configured to receive one or more messages that indicate a threshold duration associated with communication of consecutive unavailability reports from the wireless STA. The ICF component 424 is configurable or configured to transmit, while operating in a first mode of operation, a first ICF including a first unavailability report, the first unavailability report being transmitted at least the threshold duration after transmission of a second unavailability report from the wireless STA in accordance with receiving the one or more messages. The ICR component 426 is configurable or configured to receive an ICR frame in response to transmitting the first ICF.

In some examples, the ICF component 424 is configurable or configured to receive a second ICF including a request for transmission of the second unavailability report. In some examples, the ICR component 426 is configurable or configured to transmit, prior to transmitting the first ICF, a second ICR including the second unavailability report, the first unavailability report being transmitted less than the threshold duration from transmission of the second ICR frame.

In some examples, the duration component 422 is configurable or configured to receive one or more second messages that indicate one or more updates to the first mode of operation at the wireless STA, the one or more second messages further indicating a second threshold duration. In some examples, the ICF component 424 is configurable or configured to transmit a second ICF including a third unavailability report after at least the second threshold duration from transmission of a previous unavailability report.

In some examples, the ICF component 424 is configurable or configured to transmit a second ICF including a third unavailability report via a transmission opportunity associated with communication of uplink data from the wireless STA, the third unavailability report being transmitted less than the threshold duration from the second unavailability report in accordance with the third unavailability report being transmitted via the transmission opportunity that is associated with the communication of the uplink data from the wireless STA.

In some examples, the one or more messages include a beacon frame, a probe response frame, a management frame, or any combination thereof.

In some examples, the one or more messages further enable the first mode of operation at the STA.

In some examples, the first unavailability report includes a first unsolicited unavailability report, and the second unavailability report includes a second unsolicited unavailability report or a solicited unavailability report.

In some examples, the first unavailability report includes a first unsolicited unavailability report, and the second unavailability report includes a second unsolicited unavailability report.

In some examples, the first unavailability report is transmitted subsequent to the second unavailability report in accordance with the threshold duration.

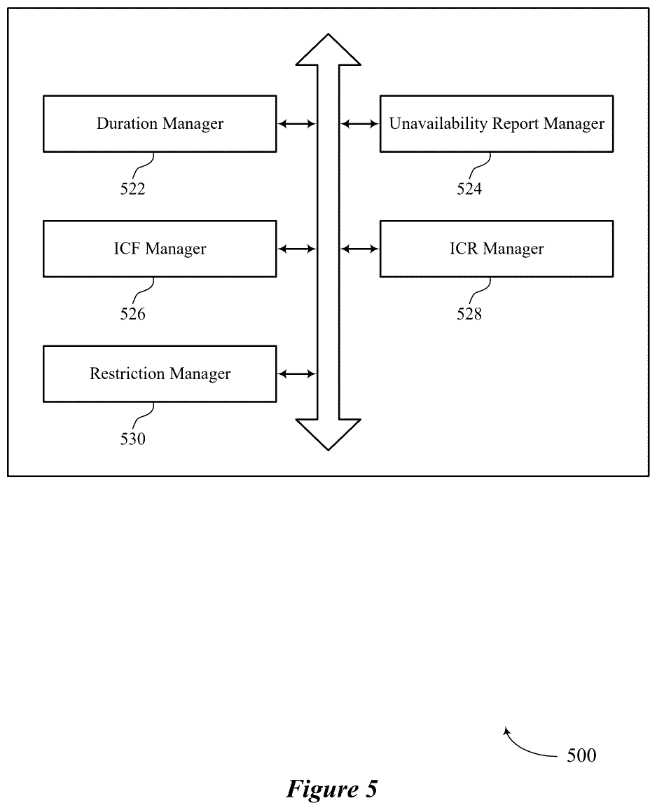

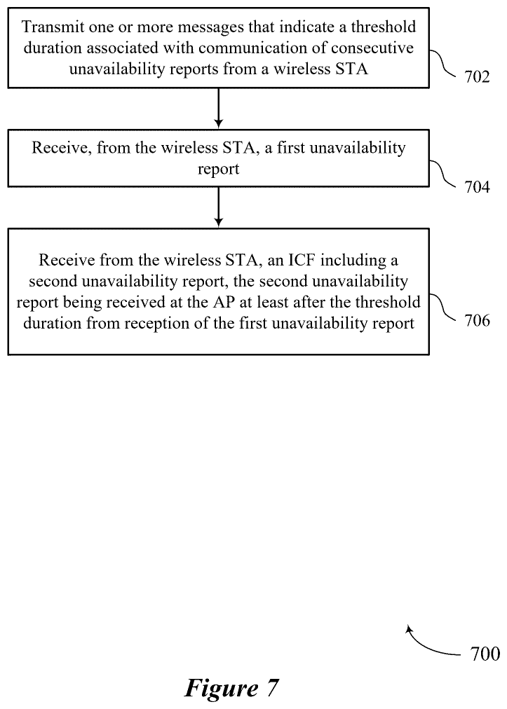

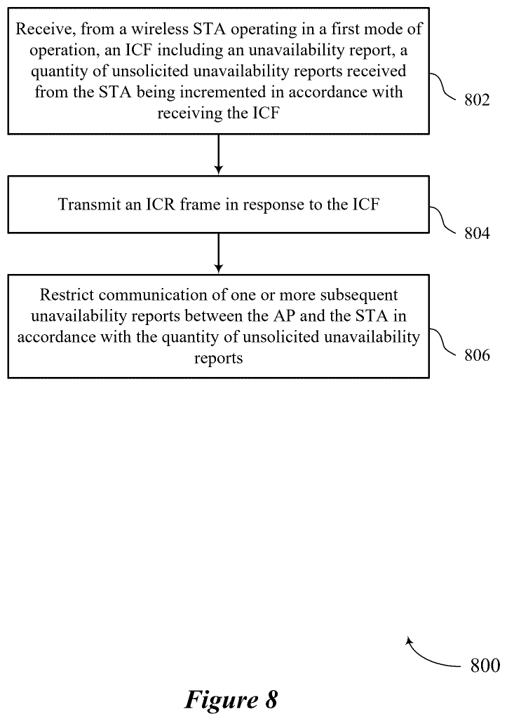

FIG. 5 shows a block diagram of an example wireless communication device 500 that supports conditions for unsolicited unavailability reporting. In some examples, the wireless communication device 500 is configured to perform the processes 700 and 800 described with reference to FIGS. 7 and 8, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP, such as the AP 102 described with reference to FIG. 1. In some other examples, the wireless communication device 500 can be an AP that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a duration manager 522, an unavailability report manager 524, an ICF manager 526, an ICR manager 528, and a restriction manager 530. Portions of one or more of the duration manager 522, the unavailability report manager 524, the ICF manager 526, the ICR manager 528, and the restriction manager 530 may be implemented at least in part in hardware or firmware. For example, one or more of the duration manager 522, the unavailability report manager 524, the ICF manager 526, the ICR manager 528, and the restriction manager 530 may be implemented at least in part by at least a processor or a modem. In some examples, portions of one or more of the duration manager 522, the unavailability report manager 524, the ICF manager 526, the ICR manager 528, and the restriction manager 530 may be implemented at least in part by a processor and software in the form of processor-executable code stored in memory.

The wireless communication device 500 may support wireless communication in accordance with examples as disclosed herein. The duration manager 522 is configurable or configured to transmit one or more messages that indicate a threshold duration associated with communication of consecutive unavailability reports from a wireless station (STA). The unavailability report manager 524 is configurable or configured to receive, from the wireless STA, a first unavailability report. The ICF manager 526 is configurable or configured to receive from the wireless STA, an ICF including a second unavailability report, the second unavailability report being received at the AP at least after the threshold duration from reception of the first unavailability report.

In some examples, the one or more messages include one or more first DUO enablement messages, and the duration manager 522 is configurable or configured to transmit one or more second DUO enablement messages that indicate a second threshold duration associated with unavailability reporting a second wireless STA, the second threshold duration being different from the threshold duration.

In some examples, the one or more messages that indicate the threshold duration include a beacon frame, a probe response frame, a management frame, or any combination thereof.

In some examples, the first unavailability report includes an unsolicited unavailability report or a solicited unavailability report.

Additionally, or alternatively, the wireless communication device 500 may support wireless communication in accordance with examples as disclosed herein. In some examples, the ICF manager 526 is configurable or configured to receive, from a wireless station (STA) operating in a first mode of operation, an ICF including an unavailability report, a quantity of unsolicited unavailability reports received from the STA being incremented in accordance with receiving the ICF. The ICR manager 528 is configurable or configured to transmit an ICR frame in response to the ICF. The restriction manager 530 is configurable or configured to restrict communication of one or more subsequent unavailability reports between the AP and the STA in accordance with the quantity of unsolicited unavailability reports.

In some examples, the restriction manager 530 is configurable or configured to transmit one or more messages that indicate a credit of unsolicited unavailability reports the STA is permitted to transmit, the credit of unsolicited unavailability reports being decremented in accordance with receiving the ICF, and restricting the communication of the one or more subsequent unavailability reports between the AP and the STA being in accordance with the credit of unsolicited unavailability reports being decremented to zero.

In some examples, the restriction manager 530 is configurable or configured to transmit, in response to receiving the ICF, one or more warning messages that indicate for the STA to reduce a frequency at which the STA communicates unsolicited unavailability reports, the one or more warning messages being transmitted in accordance with the quantity of unsolicited availability reports received from the STA satisfying a threshold quantity of unsolicited unavailability reports.

In some examples, restricting the communication of the one or more subsequent unavailability reports between the AP and the STA is in accordance with a quantity of warning messages communicated to the STA satisfying a threshold quantity of warning messages.

In some examples, restricting the communication of the one or more subsequent unavailability reports between the AP and the STA is in accordance with a failure of the STA to reduce the frequency at which the STA communicates the unsolicited unavailability reports in response to the warning message.

In some examples, restricting the communication of the one or more subsequent unavailability reports includes disassociating the STA from the AP.

In some examples, restricting the communication of the one or more subsequent unavailability reports includes disabling the first mode of operation of the STA.

In some examples, restricting the communication of the one or more subsequent unavailability reports includes suspending the first mode of operation of the STA for a duration.

In some examples, suspending the first mode of operation of the wireless STA is further in accordance with the first mode of operation being incompatible with a second mode enabled at the STA, the second mode enabled at the STA being a coordinated beamforming mode, a coordinated spatial reuse mode, or a coordinated time division multiple access mode.

FIG. 6 shows a flowchart illustrating an example process 600 performable by or at a wireless STA that supports conditions for unsolicited unavailability reporting. The operations of the process 600 may be implemented by a wireless STA or its components as described herein. For example, the process 600 may be performed by a wireless communication device, such as the wireless communication device 400 described with reference to FIG. 4, operating as or within a wireless STA. In some examples, the process 600 may be performed by a wireless STA, such as one of the STAs 104 described with reference to FIG. 1.

In some examples, in 602, the wireless STA may receive one or more messages that indicate a threshold duration associated with communication of consecutive unavailability reports from the wireless STA. The operations of 602 may be performed in accordance with examples as disclosed herein. In some implementations, aspects of the operations of 602 may be performed by a duration component 422 as described with reference to FIG. 4.

In some examples, in 604, the wireless STA may transmit, while operating in a first mode of operation, a first ICF including a first unavailability report, the first unavailability report being transmitted at least the threshold duration after transmission of a second unavailability report from the wireless STA in accordance with receiving the one or more messages. The operations of 604 may be performed in accordance with examples as disclosed herein. In some implementations, aspects of the operations of 604 may be performed by an ICF component 424 as described with reference to FIG. 4.

In some examples, in 606, the wireless STA may receive an ICR frame in response to transmitting the first ICF. The operations of 606 may be performed in accordance with examples as disclosed herein. In some implementations, aspects of the operations of 606 may be performed by an ICR component 426 as described with reference to FIG. 4.

FIG. 7 shows a flowchart illustrating an example process 700 performable by or at a wireless AP that supports conditions for unsolicited unavailability reporting. The operations of the process 700 may be implemented by a wireless AP or its components as described herein. For example, the process 700 may be performed by a wireless communication device, such as the wireless communication device 500 described with reference to FIG. 5, operating as or within a wireless AP. In some examples, the process 700 may be performed by a wireless AP, such as one of the 102 described with reference to FIG. 1.

In some examples, in 702, the wireless AP may transmit one or more messages that indicate a threshold duration associated with communication of consecutive unavailability reports from a wireless STA. The operations of 702 may be performed in accordance with examples as disclosed herein. In some implementations, aspects of the operations of 702 may be performed by a duration manager 522 as described with reference to FIG. 5.

In some examples, in 704, the wireless AP may receive, from the wireless STA, a first unavailability report. The operations of 704 may be performed in accordance with examples as disclosed herein. In some implementations, aspects of the operations of 704 may be performed by an unavailability report manager 524 as described with reference to FIG. 5.

In some examples, in 706, the wireless AP may receive from the wireless STA, an ICF including a second unavailability report, the second unavailability report being received at the AP at least after the threshold duration from reception of the first unavailability report. The operations of 706 may be performed in accordance with examples as disclosed herein. In some implementations, aspects of the operations of 706 may be performed by an ICF manager 526 as described with reference to FIG. 5.

FIG. 8 shows a flowchart illustrating an example process 800 performable by or at a wireless AP that supports conditions for unsolicited unavailability reporting. The operations of the process 800 may be implemented by a wireless AP or its components as described herein. For example, the process 800 may be performed by a wireless communication device, such as the wireless communication device 500 described with reference to FIG. 5, operating as or within a wireless AP. In some examples, the process 800 may be performed by a wireless AP, such as one of the 102 described with reference to FIG. 1.

In some examples, in 802, the wireless AP may receive, from a wireless STA operating in a first mode of operation, an ICF including an unavailability report, a quantity of unsolicited unavailability reports received from the STA being incremented in accordance with receiving the ICF. The operations of 802 may be performed in accordance with examples as disclosed herein. In some implementations, aspects of the operations of 802 may be performed by an ICF manager 526 as described with reference to FIG. 5.

In some examples, in 804, the wireless AP may transmit an ICR frame in response to the ICF. The operations of 804 may be performed in accordance with examples as disclosed herein. In some implementations, aspects of the operations of 804 may be performed by an ICR manager 528 as described with reference to FIG. 5.

In some examples, in 806, the wireless AP may restrict communication of one or more subsequent unavailability reports between the AP and the STA in accordance with the quantity of unsolicited unavailability reports. The operations of 806 may be performed in accordance with examples as disclosed herein. In some implementations, aspects of the operations of 806 may be performed by a restriction manager 530 as described with reference to FIG. 5.

Implementation examples are described in the following numbered clauses:

The following provides an overview of aspects of the present disclosure:

Aspect 1: A method for wireless communication at a wireless STA, comprising: receiving one or more messages that indicate a threshold duration associated with communication of consecutive unavailability reports from the wireless STA; transmitting, while operating in a first mode of operation, a first ICF comprising a first unavailability report, the first unavailability report being transmitted at least the threshold duration after transmission of a second unavailability report from the wireless STA in accordance with receiving the one or more messages; and receiving an ICR frame in response to transmitting the first ICF.

Aspect 2: The method of aspect 1, further comprising: receiving one or more second messages that indicate one or more updates to the first mode of operation at the wireless STA, the one or more second messages further indicating a second threshold duration; and transmitting a second ICF comprising a third unavailability report after at least the second threshold duration from transmission of a previous unavailability report.

Aspect 3: The method of any of aspects 1 through 2, further comprising: transmitting a second ICF comprising a third unavailability report via a transmission opportunity associated with communication of uplink data from the wireless STA, the third unavailability report being transmitted less than the threshold duration from the second unavailability report in accordance with the third unavailability report being transmitted via the transmission opportunity that is associated with the communication of the uplink data from the wireless STA.

Aspect 4: The method of any of aspects 1 through 3, wherein the one or more messages comprise a beacon frame, a probe response frame, a management frame, or any combination thereof.

Aspect 5: The method of any of aspects 1 through 4, wherein the one or more messages further enable the first mode of operation at the wireless STA.

Aspect 6: The method of any of aspects 1 through 5, wherein the first unavailability report comprises a first unsolicited unavailability report and the second unavailability report comprises a second unsolicited unavailability report or a solicited unavailability report.

Aspect 7: The method of any of aspects 1 through 6, wherein the first unavailability report comprises a first unsolicited unavailability report and the second unavailability report comprises a second unsolicited unavailability report.

Aspect 8: The method of any of aspects 1 through 7, the first unavailability report is transmitted subsequent to the second unavailability report in accordance with the threshold duration.

Aspect 9: A method for wireless communication at a wireless AP, comprising: transmitting one or more messages that indicate a threshold duration associated with communication of consecutive unavailability reports from a wireless STA; receiving, from the wireless STA, a first unavailability report; and receiving from the wireless STA, an ICF comprising a second unavailability report, the second unavailability report being received at the wireless AP at least after the threshold duration from reception of the first unavailability report.

Aspect 10: The method of aspect 9, wherein the one or more messages comprise one or more first DUO enablement messages, the method further comprising: transmitting one or more second DUO enablement messages that indicate a second threshold duration associated with unavailability reporting a second wireless STA, the second threshold duration being different from the threshold duration.

Aspect 11: The method of any of aspects 9 through 10, wherein the one or more messages that indicate the threshold duration comprise a beacon frame, a probe response frame, a management frame, or any combination thereof.

Aspect 12: The method of any of aspects 9 through 11, wherein the first unavailability report comprises an unsolicited unavailability report or a solicited unavailability report.

Aspect 13: A method for wireless communication at a wireless AP, comprising: receiving, from a wireless STA operating in a first mode of operation, an ICF comprising an unavailability report, a quantity of unsolicited unavailability reports received from the wireless STA being incremented in accordance with receiving the ICF; transmitting an ICR frame in response to the ICF; and restricting communication of one or more subsequent unavailability reports between the wireless AP and the wireless STA in accordance with the quantity of unsolicited unavailability reports.

Aspect 14: The method of aspect 13, further comprising: transmitting one or more messages that indicate a credit of unsolicited unavailability reports the wireless STA is permitted to transmit, the credit of unsolicited unavailability reports being decremented in accordance with receiving the ICF, and restricting the communication of the one or more subsequent unavailability reports between the wireless AP and the wireless STA being in accordance with the credit of unsolicited unavailability reports being decremented to zero.

Aspect 15: The method of any of aspects 13 through 14, further comprising: transmitting, in response to receiving the ICF, one or more warning messages that indicate for the wireless STA to reduce a frequency at which the wireless STA communicates unsolicited unavailability reports, the one or more warning messages being transmitted in accordance with the quantity of unsolicited availability reports received from the wireless STA satisfying a threshold quantity of unsolicited unavailability reports.

Aspect 16: The method of aspect 15, wherein restricting the communication of the one or more subsequent unavailability reports between the wireless AP and the wireless STA is in accordance with a quantity of warning messages communicated to the wireless STA satisfying a threshold quantity of warning messages.

Aspect 17: The method of any of aspects 15 through 16, wherein restricting the communication of the one or more subsequent unavailability reports between the wireless AP and the wireless STA is in accordance with a failure of the wireless STA to reduce the frequency at which the wireless STA communicates the unsolicited unavailability reports in response to the warning message.

Aspect 18: The method of any of aspects 13 through 17, wherein restricting the communication of the one or more subsequent unavailability reports comprises disassociating the wireless STA from the wireless AP.

Aspect 19: The method of any of aspects 13 through 18, wherein restricting the communication of the one or more subsequent unavailability reports comprises disabling the first mode of operation of the wireless STA.

Aspect 20: The method of any of aspects 13 through 19, wherein restricting the communication of the one or more subsequent unavailability reports comprises suspending the first mode of operation of the wireless STA for a duration.

Aspect 21: The method of aspect 20, wherein suspending the first mode of operation of the wireless STA is further in accordance with the first mode of operation being incompatible with a second mode enabled at the wireless STA, the second mode enabled at the wireless STA being a coordinated beamforming mode, a coordinated spatial reuse mode, or a coordinated time division multiple access mode.

Aspect 22: A wireless STA for wireless communication, comprising one or more memories storing processor-executable code, and one or more processors coupled with the one or more memories and individually or collectively operable to execute the code to cause the wireless STA to perform a method of any of aspects 1 through 8.

Aspect 23: A wireless STA for wireless communication, comprising at least one means for performing a method of any of aspects 1 through 8.

Aspect 24: A non-transitory computer-readable medium storing code for wireless communication, the code comprising instructions executable by one or more processors to perform a method of any of aspects 1 through 8.

Aspect 25: A wireless AP for wireless communication, comprising one or more memories storing processor-executable code, and one or more processors coupled with the one or more memories and individually or collectively operable to execute the code to cause the wireless AP to perform a method of any of aspects 9 through 12.

Aspect 26: A wireless AP for wireless communication, comprising at least one means for performing a method of any of aspects 9 through 12.

Aspect 27: A non-transitory computer-readable medium storing code for wireless communication, the code comprising instructions executable by one or more processors to perform a method of any of aspects 9 through 12.

Aspect 28: A wireless AP for wireless communication, comprising one or more memories storing processor-executable code, and one or more processors coupled with the one or more memories and individually or collectively operable to execute the code to cause the wireless AP to perform a method of any of aspects 13 through 21.

Aspect 29: A wireless AP for wireless communication, comprising at least one means for performing a method of any of aspects 13 through 21.

Aspect 30: A non-transitory computer-readable medium storing code for wireless communication, the code comprising instructions executable by one or more processors to perform a method of any of aspects 13 through 21.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless station (STA), comprising:
a processing system that includes processor circuitry and memory circuitry that stores code, the processing system configured to cause the wireless STA to:
receive one or more messages that indicate a threshold duration associated with communication of consecutive unavailability reports from the wireless STA;
transmit, while operating in a first mode of operation, a first initial control frame comprising a first unavailability report, the first unavailability report being transmitted at least the threshold duration after transmission of a second unavailability report from the wireless STA in accordance with receiving the one or more messages; and
receive an initial control response frame in response to transmitting the first initial control frame.

2. The wireless STA of claim 1, wherein the processing system is further configured to cause the wireless STA to:
receive one or more second messages that indicate one or more updates to the first mode of operation at the wireless STA, the one or more second messages further indicating a second threshold duration; and
transmit a second initial control frame comprising a third unavailability report after at least the second threshold duration from transmission a previous unavailability report.

3. The wireless STA of claim 1, wherein the processing system is further configured to cause the wireless STA to:
transmit a second initial control frame comprising a third unavailability report via a transmission opportunity associated with communication of uplink data from the wireless STA, the third unavailability report being transmitted less than the threshold duration from the second unavailability report in accordance with the third unavailability report being transmitted via the transmission opportunity that is associated with the communication of the uplink data from the wireless STA.

4. The wireless STA of claim 1, wherein the one or more messages comprise a beacon frame, a probe response frame, a management frame, or any combination thereof.

5. The wireless STA of claim 1, wherein the one or more messages further enable the first mode of operation at the STA.

6. The wireless STA of claim 1, wherein the first unavailability report comprises a first unsolicited unavailability report and the second unavailability report comprises a second unsolicited unavailability report or a solicited unavailability report.

7. The wireless STA of claim 1, wherein the first unavailability report comprises a first unsolicited unavailability report and the second unavailability report comprises a second unsolicited unavailability report.

8. The wireless STA of claim 1, wherein the first unavailability report is transmitted subsequent to the second unavailability report in accordance with the threshold duration.

9. A wireless access point (AP), comprising:
a processing system that includes processor circuitry and memory circuitry that stores code, the processing system configured to cause the wireless AP to:
transmit one or more messages that indicate a threshold duration associated with communication of consecutive unavailability reports from a wireless station (STA);
receive, from the wireless STA, a first unavailability report; and
receive from the wireless STA, an initial control frame comprising a second unavailability report, the second unavailability report being received at the AP at least after the threshold duration from reception of the first unavailability report.

10. The wireless AP of claim 9, wherein the one or more messages comprise one or more first dynamic unavailability operation enablement messages, and the processing system is further configured to cause the wireless AP to:
transmit one or more second dynamic unavailability operation enablement messages that indicate a second threshold duration associated with unavailability reporting a second wireless STA, the second threshold duration being different from the threshold duration.

11. The wireless AP of claim 9, wherein the one or more messages that indicate the threshold duration comprise a beacon frame, a probe response frame, a management frame, or any combination thereof.

12. A wireless access point (AP), comprising:
a processing system that includes processor circuitry and memory circuitry that stores code, the processing system configured to cause the wireless AP to:
receive, from a wireless station (STA) operating in a first mode of operation, an initial control frame comprising an unavailability report, a quantity of unsolicited unavailability reports received from the wireless STA being incremented in accordance with receiving the initial control frame;
transmit an initial control response frame in response to the initial control frame; and
restrict communication of one or more subsequent unavailability reports between the wireless AP and the wireless STA in accordance with the quantity of unsolicited unavailability reports.

13. The wireless AP of claim 12, wherein the processing system is further configured to cause the wireless AP to:
transmit one or more messages that indicate a credit of unsolicited unavailability reports the wireless STA is permitted to transmit, the credit of unsolicited unavailability reports being decremented in accordance with receiving the initial control frame, and restricting the communication of the one or more subsequent unavailability reports between the wireless AP and the wireless STA being in accordance with the credit of unsolicited unavailability reports being decremented to zero.

14. The wireless AP of claim 12, wherein the processing system is further configured to cause the wireless AP to:
transmit, in response to receiving the initial control frame, one or more warning messages that indicate for the wireless STA to reduce a frequency at which the wireless STA communicates unsolicited unavailability reports, the one or more warning messages being transmitted in accordance with the quantity of unsolicited availability reports received from the wireless STA satisfying a threshold quantity of unsolicited unavailability reports.

15. The wireless AP of claim 14, wherein restricting the communication of the one or more subsequent unavailability reports between the wireless AP and the wireless STA is in accordance with a quantity of warning messages communicated to the wireless STA satisfying a threshold quantity of warning messages.

16. The wireless AP of claim 14, wherein restricting the communication of the one or more subsequent unavailability reports between the wireless AP and the wireless STA is in accordance with a failure of the wireless STA to reduce the frequency at which the wireless STA communicates the unsolicited unavailability reports in response to the one or more warning messages.

17. The wireless AP of claim 12, wherein restricting the communication of the one or more subsequent unavailability reports comprises disassociating the wireless STA from the wireless AP.

18. The wireless AP of claim 12, wherein restricting the communication of the one or more subsequent unavailability reports comprises disabling the first mode of operation of the wireless STA.

19. The wireless AP of claim 12, wherein restricting the communication of the one or more subsequent unavailability reports comprises suspending the first mode of operation of the wireless STA for a duration.

20. The wireless AP of claim 19, wherein suspending the first mode of operation of the wireless STA is further in accordance with the first mode of operation being incompatible with a second mode enabled at the wireless STA, the second mode enabled at the wireless STA being a coordinated beamforming mode, a coordinated spatial reuse mode, or a coordinated time division multiple access mode.
